(19) United States
(12) Patent Application Publication
(10) Pub. No.: US 2023/0038401 A1
(43) Pub. Date: Feb. 9, 2023

(54) METHOD OF MAINTAINING GRATE OF GRINDING MILL AND MAINTENANCE ARRANGEMENT

(71) Applicant: Metso Outotec Finland Oy, Tampere (FI)

(72) Inventor: Nicholas John Green, Oslo (NO)

(73) Assignee: Metso Outotec Finland Oy, Tampere (FI)

(21) Appl. No.: 17/789,029

(22) PCT Filed: Dec. 30, 2019
(86) PCT No.: PCT/FI2019/050930

§ 371 Date: Jun. 24, 2022

(51) Int. Cl. B02C 23/00; B02C 17/22; B07B 1/46

(52) U.S. Cl. CPC B02C 23/00; B02C 17/22; B07B 1/4627; B02C 2210/02; B02C 2023/165

(57) ABSTRACT

A method of maintaining a grate of a grinding mill, the method comprising the steps of gripping a worn rotable segment comprising at least one grate support element provided with a mounting flange at the outer perimeter of the grate support element configured to mount the grate support element to a shell of the grinding mill, and at least one grate panel attached to the grate support element. The method further comprises unmounting, from the outside of the grinding mill, the mounting flange of the grate support element from the shell of the grinding mill, and lifting the unmounted worn rotable segment from the grinding mill.

### BACKGROUND

The present invention relates to grinding mills, and more particularly to a method of maintaining a grate of a grinding mill and a maintenance arrangement.

Grinding mills, specifically those used in minerals and metals processing operations, operate continuously, only stopping to perform essential and preventative maintenance. Therefore the time taken to perform maintenance directly affects the productivity of the grinding mill and therefore production of the minerals or metals processing operation.

### BRIEF DESCRIPTION OF THE INVENTION

An object of the present invention is thus to provide a new method of maintaining a grate of a grinding mill and a maintenance arrangement for implementing the method. The objects of the invention are achieved by a method and an arrangement that are characterized by what is stated in the independent claims. Preferred embodiments of the invention are disclosed in the dependent claims.

The current solution is based on the idea of maintaining a grate of a grinding mill from the outside without a need to unmount the worn structures from the inside of the grinding mill, which is typically slow, difficult and includes many work phases requiring human involvement.

An advantage of the method according to the current solution is that the maintenance of the grate is quicker and easier. The method according to the current solution also enables more efficient use of machinery and even robots and automation. The current solution can, therefore, reduce the number and/or duration of maintenance breaks needed and improve occupational safety.

### BRIEF DESCRIPTION OF THE DRAWINGS

In the following the invention will be described in greater detail by means of preferred embodiments with reference to the attached [accompanying] drawings, in which

FIG. 1 illustrates schematically a grinding mill seen from a side;

FIG. 2 illustrates schematically an open-ended grinding mill seen from the second end;

FIG. 3 shows a part of an open-ended grinding mill in perspective;

FIG. 4 shows a detail from a discharge end of an open-ended grinding mill in perspective;

FIG. 5 shows a detail from a discharge end of an open-ended grinding mill shown from a side of the grinding mill;

FIG. 6 shows a grate support element according to an example of an embodiment;

FIG. 7 shows a grate panel according to an example of an embodiment;

FIG. 8 shows a detail of a prior art grinding mill;

FIG. 9 shows a detail of a grinding mill according to the current solution;

FIG. 10 illustrates an embodiment of a method of maintaining a grate of a grinding mill;

FIG. 11 shows a rotable segment of a grate of a grinding mill; and

FIG. 12 illustrates a maintenance arrangement provided on a grinding mill.

The drawings are for illustrative purposes only and are not shown is scale. For the sake of clarity, not all the similar features have been numbered in the figures.

### DETAILED DESCRIPTION OF THE INVENTION

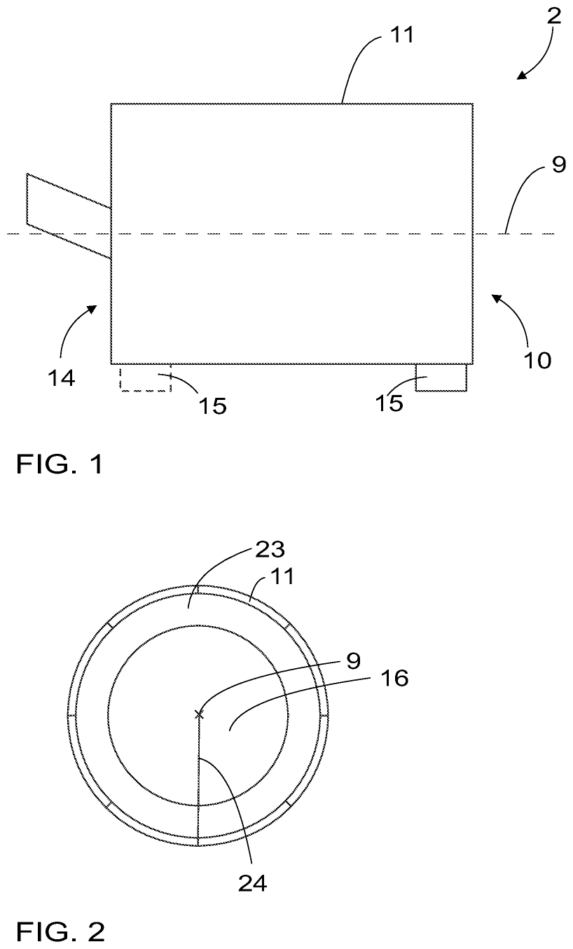

FIG. 1 illustrates schematically a grinding mill 2. FIG. 2 illustrates schematically a grinding mill 2 seen from a second end 10, in other words the discharge end 10 of the grinding mill. FIGS. 1 and 2 only show some features of the grinding mill 1 that help understanding the current solution. It is clear for a person skilled in the art that a grinding mill may and usually does comprise other features as well.

A grinding mill 2, such as the grinding mill of FIG. 1, comprises a drum comprising a cylindrical shell 11. In a grinding mill 2 of the current solution, the longitudinal axis 9 of the drum is arranged in a substantially horizontal position in a use position of the grinding mill 2. The longitudinal axis 9 of the drum refers to the axis extending along the centre line of the shell 11 from one end of the cylinder-shaped shell to another. Horizontal position refers to the longitudinal axis 9 extending in a substantially horizontal direction. In other words, the longitudinal axis 9 extends in a direction that is closer to a horizontal direction than a vertical direction. The use position refers to a position the grinding mill 2 is arranged in when used for grinding, for instance for ore grinding, in a production environment.

The drum comprises a first end 14 at the feed end of the shell and a second end at the discharge end 10 of the shell. The feed end refers to the end at which the material to be ground is fed into the drum. The discharge end refers to the end at which the ground material is discharged from the drum. In wet grinding applications the discharged material comprising ground material and possibly liquids is also called slurry in this application.

The grinding mill 2 may comprise various process duties including but not limited to a ball mill, a pebble mill, an autogenous mill (AG mill), or a semi-autogenous mill (SAG mill). Working principles of such grinding mills are known and are not explained in more detail in this description.

The grinding mill 2 typically further comprises a bearing 15 supporting the drum at the discharge end 10. The bearing 15 may comprise any suitable type of bearing, such as a roller bearing, a hydrostatic bearing, a hydrodynamic bearing or a ball bearing. It should also be noted that the grinding mill 2 may also have additional bearings supporting the drum and/or other parts of the grinding mill 2. Such bearings 15 for supporting the drum of the grinding mill are known as such and are not explained in more detail.

A grinding mill 2 may be an open-ended grinding mill. Open-ended grinding mill refers to a grinding mill that does not have a discharge trunnion, pulp lifters to lift the ground material to the discharge trunnion or a solid discharge head plate. An open-ended grinding mill may comprise a discharge grate 16 instead of the discharge trunnion, pulp lifter and solid discharge head plate, whereby the ground material is discharged through the discharge grate 16. In a fully open-ended grinding mill, there is no need to lift the ground material to discharge it. According to another embodiment, the open-ended grinding mill 2 may comprise a partial head plate 23 at the discharge end. Such a grinding mill may also be called a semi-open-ended grinding mill. A semi-open-ended grinding mill may be similar to the fully open-ended grinding mill, but it may have a partial head plate 23 at the discharge end of the shell extending partially from a perimeter of the shell 11 towards the longitudinal axis 9 of the drum, but no discharge trunnion and no traditional pulp lifters. The partial head plate 23 at the discharge end 10 of the shell 11 may extend a distance of preferably less than 50 percent, more preferably less than 30 percent and most preferably less than 15 percent of the length the radius 24 of the shell from the edge of the shell 11 towards the longitudinal axis 9 of the drum. The area of the discharge end 10 of the drum extending from the inner edge of the partial head plate 23 towards the longitudinal axis 9 of the drum may define a discharge opening. The discharge opening may be provided with a discharge grate 16. In both types of open-ended grinding mills, in other words in both fully open-ended and semi-open-ended grinding mills, the ground material may, thus, be discharged from the discharge grate 16 straight to the atmosphere.

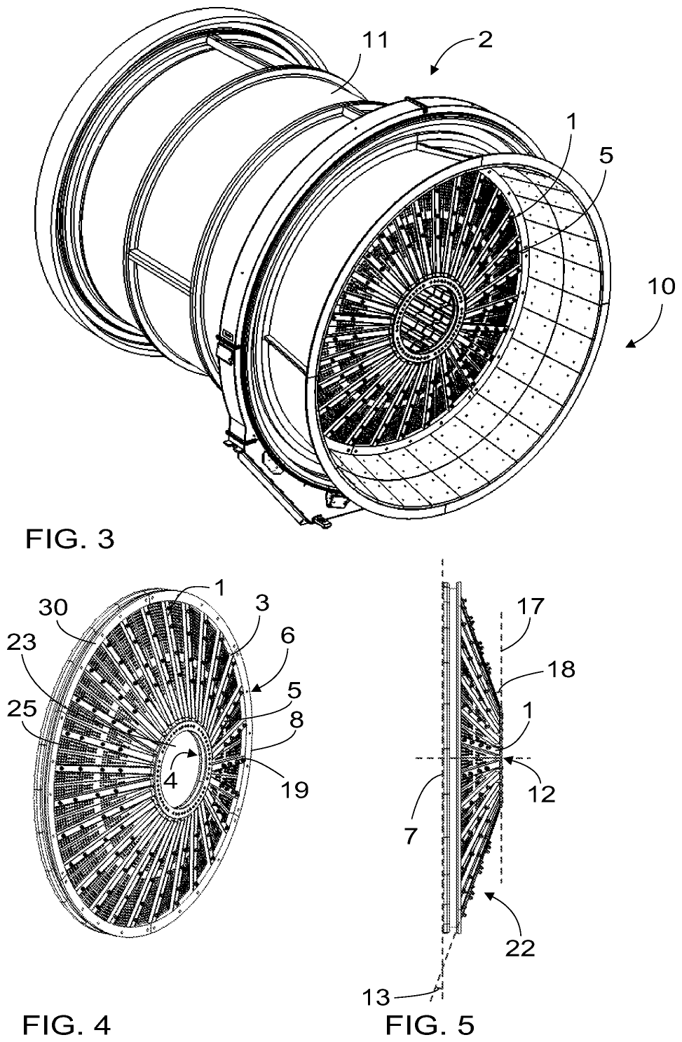

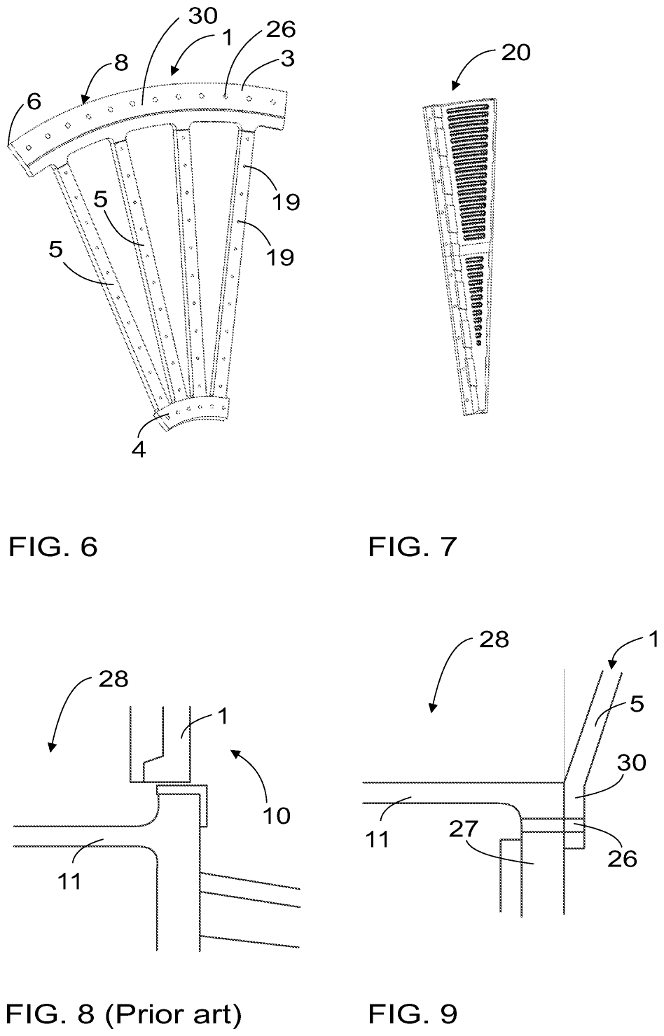

FIG. 3 shows a part of a grinding mill 2, more particularly a part of an open-ended grinding mill 2, in perspective, FIG. 4 shows a detail from a discharge end of an open-ended grinding mill in perspective, and FIG. 5 shows a detail from a discharge end of an open-ended grinding mill shown from a side of the grinding mill. FIG. 6 shows a grate support element according to an example of an embodiment, and FIG. 7 shows a grate panel according to an example of an embodiment.

According to an aspect and referring to the FIGS. 3 to 7, for example, a grate support element 1 for an open-ended grinding mill 2 may comprise an outer perimeter section 3, an inner section 4, and at least one vane 5. The vane 5 may be configured to extend between the outer perimeter section 3 and the inner section 4 in a direction radial with respect to the outer perimeter 6 of the grate support element 1.

The grate support element 1, thus, refers to an element configured to be mounted at a discharge end 10 of a shell 11 of the open-ended grinding mill 2 and to support one or more grate panel(s) of the open-ended grinding mill 2. The inner section 4 refers to the section of the grate support element 1, which is provided at the end of the grate support element 1 that is directed towards the middle 12 of the cross section of the grinding mill 2 at the discharge end 10, when the grate support element 1 is mounted to the grinding mill 2. Similarly, the outer perimeter section 3 refers to the section of the grate support element 1, which is provided at the end of the grate support element 1 that is directed away from the middle 12 of the cross section of the grinding mill 2 at the discharge end 10, when the grate support element 1 is mounted to the grinding mill 2, in other words at the distal end of the grate support element 1.

FIG. 8 shows a detail of a prior art grinding mill at the discharge end and FIG. 9 shows a detail of a grinding mill according to the current solution at the discharge end.

According to an aspect, a grate support element 1 for supporting a grate 25 of an open-ended grinding mill 2 comprises an outer perimeter section 3 directed towards a middle 12 of the cross section of the grinding mill 2 in the transverse direction of the grinding mill 2, an inner section 4 directed away from the middle 12 of the cross section of the grinding mill 2 in the transverse direction of the grinding mill, and at least one vane 5 extending between the outer perimeter section 3 and the inner section 4 in such a manner that the vane 5 has an inner section side end connected to the inner section 4 and an outer perimeter section side end connected to the outer perimeter section 3. The vane 5 extending between the outer perimeter section 3 and the inner section 4 in such a manner that the vane 5 has an inner section side end connected to the inner section 4 and an outer perimeter section side end connected to the outer perimeter section 3 refers to the vane having a first end at the outer perimeter section and another end a second end at the inner section of the grate support element.

The grate support element 1 further comprises a mounting flange 30 at the outer perimeter of the grate support element 1. The mounting flange 30 is configured to enable mounting of the grate support element 1 to a shell 11 of the grinding mill 2. The mounting flange 30 extends outwards from the middle 12 of the cross section of the grinding mill 2. In other words, the mounting flange 30 extends from the outer perimeter end of the vane 5 in a direction directed outwards from the middle 12 of the cross section of the grinding mill 2. Thus, the mounting flange 30 forms a flange with a shape of a ring or a section of a ring at the outer perimeter section 3 part of the grate support element 1. Thereby, the mounting flange 30 is configured to extend beyond the inner perimeter of the shell 11 at the discharge end 10 and not to extend to the area of the discharge end opening of the shell 11, when the grate support element 1 is mounted to the grinding mill 2, for example to the shell 11. Thus, the mounting flange 30 is configured to be mounted to the discharge end face of the grinding mill 2, and the shell 11, and not to protrude into the inside or inner volume 28 of the shell 11, when the grate support element 1 is mounted to the grinding mill 2 via the mounting flange 30.

According to an embodiment, the mounting flange 30 is configured to extend in a vertical direction, when the grate support element 1 is mounted in the grinding mill. According to another embodiment, the mounting flange 30 is configured to extend in a direction angled with respect to a vertical direction, when the grate support element 1 is mounted in the grinding mill 2. According to an embodiment, the angle of the mounting flange 30 may be equal to the angle of the vane 5 at the outer perimeter section side end of the vane. According to another embodiment, the angle of the mounting flange 30 may be different from the angle of the vane 5 at the outer perimeter section side end of the vane 5.

According to an embodiment, the mounting flange 30 is provided with flange openings 26 for bolts for mounting the grate support. The flange openings 26 may be configured to extend through the mounting flange 30 in a horizontal direction, when the grate support element 1 is mounted in the grinding mill 2. In other words, the flange openings 26 may be configured to extend in the longitudinal direction of the grinding mill 2, when the grate support element 1 is mounted to the grinding mill 2. According to another embodiment, at least some of the flange openings 26 may be configured as blind holes

According to an embodiment, the mounting flange 30 is configured to extend outwards beyond a diameter of an inner volume 28 of the shell 11 of the grinding mill 2, when the grate support element 1 is mounted in the grinding mill 2. In other words, the mounting flange 30 is configured not to protrude to the area inside the inner perimeter of the cylindrical shell 11 of the grinding mill 2, when the grate support element 1 is mounted to the grinding mill 2. This has many benefits including not limiting the flow of ground material and avoiding a surface of high wear and a point of stiffness discontinuity at the discharge end of the shell 11.

According to an embodiment, the grate support element 1 comprises a mounting surface parallel to the end of the of the shell 11 of the grinding mill 2. Preferably, this mounting surface comprises a surface within the area of the mounting flange 30. More preferably, this mounting surface comprises a surface within the area of the mounting flange 30 configured to be directed towards the shell 11, when the grate support element 1 is mounted to the grinding mill 2, such as to the discharge end of the shell.

According to an embodiment, the vane 5 extends between the outer perimeter section 3 and the inner section 4 in a direction radial with respect to the cross section of the grinding mill 2 in the transverse direction. In such an embodiment, the vanes 5 may thus be configured to extend radially from the outer perimeter of the discharge end of the shell 11, when a plurality of grate support elements 1 or one or more grate support elements 1 comprising a plurality of vanes 5 are mounted to the grinding mill 2.

According to an embodiment, the vane 5 extends between the outer perimeter section 3 and the inner section 4 in a curved manner. In such embodiments, the vanes may be configured to curve for instance in a direction of a plane defined by the vanes 5 or in a direction transverse to the direction of the plane defined by the vanes 5. The plane defined by the vanes refers to a plane defined by the direction, in which the vane 5 extends from the outer perimeter section 3 towards the inner section 4. Thus, a curve in a direction of the plane refers to the vane being curved, or angled, with respect to the radial direction directed from the outer perimeter edge 8 towards the middle 12 of the of the cross section of the grinding mill 2, when the grate support element 1 is mounted to a grinding mill 2. The vane 5 may for instance be configured to extend from the outer perimeter section 3 towards the inner section in a spiraling manner. Similarly, a curve in a direction transverse to the direction of the plane defined by the vanes 5 refers to the vane 5 being configured to be curved towards and/or outwards from the volume of the grinding mill 2, when mounted to the grinding mill 2. According to an embodiment, the angle or the curvature may vary along the length of the vane 5.

According to an embodiment, an open-ended grinding mill 2 comprises a shell 11 comprising an inner volume 28 for material to be ground and at least one grate support element 1 according to an embodiment described in this description, or a combination of such embodiments, mounted to the shell at a discharge end 10 of the grinding mill 2. According to an embodiment, the shell 11 comprises a shell flange 27 extending in a radial direction away from the inner volume of the shell 11, and the grate support element 1 is mounted via the mounting flange 30 to the shell flange 27.

According to an embodiment, the mounting flange 30 and the shell flange 27 are provided with flange openings 26 for bolts for mounting the grate support element 1 to the shell 11. Preferably, at least some of the flange openings 26 are configured to be aligned when the grate support element 1 is mounted to the shell 11. The flange openings 26 in the mounting flange 30 and in the shell flange 26 are preferably configured to extend through the mounting flange 30. The grate support element 1 is preferably mounted to the shell 11 by bolts extending in a horizontal direction through the flange openings 26 in both the mounting flange 30 and the shell flange 27, when the grate support element 1 is mounted in the grinding mill 2 and the grinding mill 2 is in a use position.

According to an embodiment, the vane 5 is provided with at least two vane openings 19 along its length for attaching the grate support element 1 to a grate panel 20.

According to an embodiment, the vane 5 may be angled with respect to a plane 7 defined by the outer edge 8 of the outer perimeter section 3 in such a manner that the inner section 4 is configured to be provided outwards from the plane 7 defined by the outer edge 8 of the outer perimeter section 3, when the grate support element 1 is mounted to the open-ended grinding mill 2. Thus, the vane 5 may be angled with respect to a plane defined by the outer perimeter of the grate support element 1. In other words, the inner section 4 may protrude outwards from the grinding mill volume 28, when the grate support element 1 is mounted to the open-ended grinding mill 2, more particularly at a discharge end 10 of the open-ended grinding mill 2.

According to another embodiment, the grate support element 1 may be flat. In other words, the vane 5 may extend in a direction parallel, or substantially parallel, to the plane 7 defined by the outer edge 8 of the outer perimeter section 3, instead of being angled to the plane. In such an embodiment, the grate support element 1 in its entirety may, thus, be configured to be positioned into a vertical position when mounted to the grinding mill 2, instead of protruding outwards from the volume 28 of the grinding mill 2. The embodiments may otherwise be similar to one another and comprise similar features and combinations thereof.

According to an embodiment, the angle 13 between the vane 5 and the plane 7 defined by the outer edge 8 of the outer perimeter section 3 is in the range of 5 to 30 degrees. In other words, the vane 5 protrudes outwards from the grinding mill volume, in other words from the inside of the shell 11, at an angle 13 in the range of 5 to 30 degrees, when the grate support element 1 is mounted to the open-ended grinding mill 2, more particularly at a discharge end 10 of the open-ended grinding mill 2.

According to an embodiment, the grate support element 1 comprises a shape of a conical wheel or a conical disc, or a shape of a section of a conical wheel or a conical disc. The grate support element 1 comprising a shape of a section of a conical wheel or a conical disc refers to such a shape that a plurality of grate support elements 1 arranged adjacently to one other in such a manner, that their inner sections 4 are directed to a common middle point and their outer perimeter sections 3 are directed away from the common middle point, form a conical wheel shape or a conical disc shape.

According to an embodiment, the grate support element 1 and a grate panel 20 are attached fixedly to one another to form a uniform structure. According to another embodiment, one grate support element 1 alone forms a grate support structure 22.

According to an embodiment, a grate support structure 22 comprises at least two grate support elements 1 described in this description and the accompanying drawings.

According to an embodiment, an open-ended grinding mill 2 comprises a grate support structure 22 and/or at least one grate support element 1 described in this description. According to an embodiment, such an open-ended grinding mill 2 further comprises a grate 25 and a cylindrical shell 11, and the grate support structure 22 is mounted to the grate 25 and the cylindrical shell 11. According to a further embodiment, the grate support structure 22 is mounted removably at least to the cylindrical shell 11.

According to an embodiment, in an open-ended grinding mill 11 described in this description, the middle part of the grate support structure 22 comprising the inner section of the grate support structure 22 extends outwards from the cylindrical shell. More particularly, in such an embodiment, the middle part of the grate support structure 22 comprising the inner section of the grate support structure 22 extends outwards from the cylindrical shell 2 in the longitudinal direction of the cylindrical shell 11.

According to an embodiment, the inner section 4 connecting the vanes 5 at the middle end of the grate support element 1 is configured to form a ring-like inner perimeter for the grate support element. According to another embodiment, the inner section 4 connecting the vanes 5 at the middle end of the grate support element 1 is configured to form a solid round centre part for the grate support element 1.

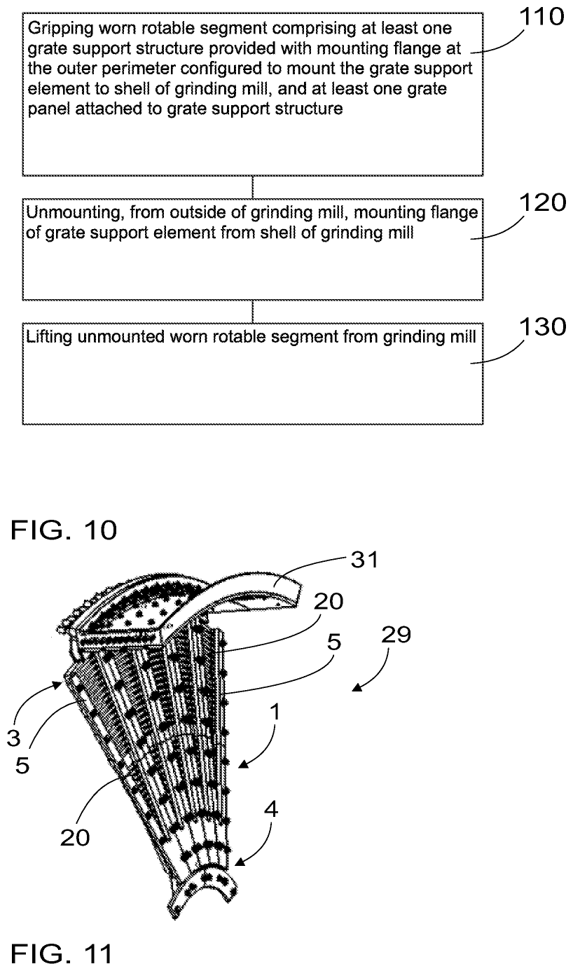

FIG. 10 illustrates an embodiment of a method of maintaining a grate of a grinding mill. A method according to an embodiment illustrated in FIG. 10 comprises the steps of gripping 110 a worn rotable segment 29 comprising at least one grate support element 1 provided with a mounting flange 30 at the outer perimeter 6 of the grate support element 1 configured to mount the grate support element 1 to a shell of the grinding mill 2, and at least one grate panel 20 attached to the grate support element 1; unmounting 120, from the outside of the grinding mill, the mounting flange of the grate support element from the shell of the grinding mill; and lifting 130 the unmounted worn rotable segment from the grinding mill 2.

According to an embodiment, the mounting flange 30 may be provided as an integral part of the grate support element 1. According to another embodiment, the mounting flange 30 may be provided as a separate structural part and be configured to be connected to the grate support element fixedly or removably.

According to an embodiment, the rotable segment 29 may be gripped using standard gripping equipment used in lifting objects, such as hoisting cables, shackles and the like known as such. According to an embodiment, the rotable segment 29 may be gripped using tailored gripping equipment configured to grip and lift a rotable segment 29. According to an embodiment, such a tailored gripping equipment may comprise at least of the following: a gripping device, a jaw type device, lifting lugs or a jig.

According to an embodiment, the grate support element 1 and, thus, the rotable segment 29, may be configured to be mounted to the shell 11 of the grinding mill 2 by removable mounting equipment, such as bolts. In such embodiments, unmounting the grate support element 1, and, thus, the rotable segment 29, may comprise removing the bolts.

Lifting the unmounted worn rotable segment 29 from the grinding mill 2 refers to lifting the rotable segment 29 from its place in the grinding mill and lifting it off to be refurbished, recycled or disposed.

According to an embodiment, the method of maintaining a grate of a grinding mill may further comprise the steps of lifting a new rotable segment 29 or a refurbished rotable segment 29 to the part of the grinding mill 2, where the worn rotable segment 29 has been removed, and mounting, from the outside of the grinding mill, the new or refurbished rotable segment 29 to the shell 11 of the grinding mill at the mounting flange.

According to an embodiment, the rotable segment 29 may comprise at least two grate support elements 1. According to an embodiment, the rotable segment 29 may comprise at least three grate panels.

According to an embodiment, the grate 25 of the grinding mill 2 may be formed of 3 to 12 rotable segments, whereby each of the rotable segments 29 forms a segment of the grate 25 in the range of 30 to 120 degrees of the complete grate. In other words, a grate of a grinding mill 2 may be formed of 3 to 12 rotable segment 29 mounted adjacent to one another in a radial manner, each inner section 4 directed towards the middle 12 of the of the cross section of the grinding mill 2, to form a round grate 25. Thus, in an embodiment, the grate 25 may for instance comprise 3 rotable segments each forming a 120-degree segment of the grate, and in another embodiment, the grate 25 may comprise 4 rotable segments each forming a 90-degree segment of the grate 25 and so on. A benefit of such embodiments is that the rotable segments 29 are lighter and easier to handle than in embodiments, where one or two rotable segments form the grate. However, according to further embodiments, the grate 25 may be formed of rotable segments each forming a smaller than 30-degree segment of the grate or larger than a 120-degree segment of the grate. According to a further embodiment, at least one of the rotable segments 29 of the grate 25 may be configured to have a different size, in other words a larger or smaller angle, than at least on other rotable segment 29 of the same grate 25. For instance, a grate 25 could comprise two 45-degree rotable segments 29 and two 135-degree rotable segments 29.

According to an embodiment, the method of maintaining a grate of a grinding mill may further comprise stopping the grinding mill 2 to such a position that the worn rotable segment is provided above the charge before being gripped, unmounted and lifted away from the grinding mill. For instance, the grinding mill 2 may be stopped at a position, where the rotable segment 29 to be replaced is provided at the top or close to the top of the grate 25. A benefit of such embodiment is that it is easier to replace a rotable segment without stopping the process completely and emptying the shell 11 from slurry and ground material for the maintenance is not necessary.

According to an embodiment, the rotable segment 29 may comprise in addition to grate support elements 1 and grate panels 20 at least one of the following: a radial lifter (not shown) or a segment of a discharge cone 31.

According to an embodiment, the worn and/or new or refurbished rotable segment is lifted by a relining crane (not shown). Such a relining crane may be mounted for instance on the outside of the grinding mill 2 and it may be configure to be used for lifting the worn rotable segment and the new or refurbished rotable segment 29. According to an embodiment, the relining crane may be a fixed base relining crane. According to an embodiment, the relining crane may be provided with gripping equipment for gripping on the rotable segment.

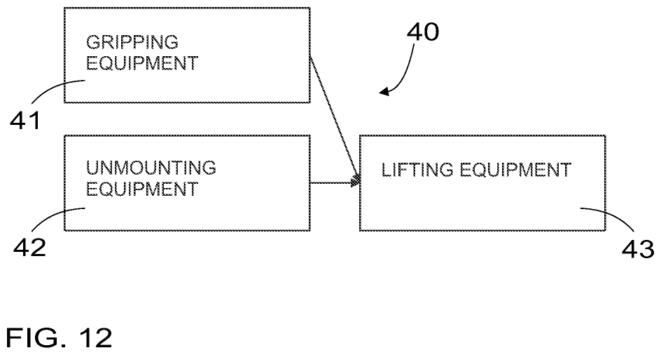

FIG. 12 illustrates a maintenance arrangement 40 provided on a grinding mill 2. Such a maintenance arrangement 40 may comprise gripping equipment 41 configured to grip a worn rotable segment 29 comprising at least one grate support element 1 provided with a mounting flange 30 at the outer perimeter of the grate support element 1 that is configured to mount the grate support element 1 to a shell 11 of the grinding mill 2, and at least one grate panel 20 attached to the grate support element 1; unmounting equipment 42 configured to unmount, from the outside of the grinding mill 2, the mounting flange 30 of the grate support element 1 from the shell 11 of the grinding mill 2; and lifting equipment 43 configured to lift the unmounted worn rotable segment from the grinding mill.

According to an embodiment, the maintenance arrangement 40 further comprises mounting equipment (not shown). Depending on the embodiment, the mounting equipment for mounting the rotable segment via the mounting flange 30 may comprise the same equipment as the unmounting equipment 42, or separate equipment. In other words, the same or different equipment may be used for mounting and unmounting the rotable segment 29.

According to an embodiment, the lifting equipment 43 may comprise a relining crane that is mounted on the outside of the grinding mill 2 and configured to lift the worn rotable segment 29 and the new rotable segment 29. According to an embodiment, the relining crane may be a fixed base relining crane. According to an embodiment, the relining crane may be provided with the gripping equipment 41 for gripping on the rotable segment 29. According to a further embodiment, a relining machine, which is not fixedly mounted, may be used instead of a fixed relining crane.

It will be obvious to a person skilled in the art that, as the technology advances, the inventive concept can be implemented in various ways. The invention and its embodiments are not limited to the examples described above but may vary within the scope of the claims.

1. A method of maintaining a grate of a grinding mill, the method comprising the steps of
gripping a worn rotable segment comprising at least one grate support element provided with a mounting flange at the outer perimeter of the grate support element configured to mount the grate support element to a shell of the grinding mill, and at least one grate panel attached to the grate support element,
unmounting, from the outside of the grinding mill, the mounting flange of the grate support element from the shell of the grinding mill, and
lifting the unmounted worn rotable segment from the grinding mill.

2. A method according to claim 1, wherein the method further comprises the steps of
lifting a new rotable segment or a refurbished rotable segment to the part of the grinding mill, where the worn rotable segment has been removed, and
mounting, from the outside of the grinding mill, the new or refurbished rotable segment to the shell of the grinding mill at the mounting flange.

3. A method according to claim 1, wherein the rotable segment comprises at least two grate support elements.

4. A method according to claim 1, wherein the rotable segment comprises at least three grate panels.

5. A method according to claim 1, wherein the grate of the grinding mill is formed of 3 to 12 rotable segments, whereby each of the rotable segments forms a segment of the grate in the range of 30 degrees to 120 degrees of the complete grate.

6. A method according to claim 1, wherein the method further comprises
stopping the grinding mill to such a position that the worn rotable segment is provided above the charge before being gripped, unmounted and lifted away from the grinding mill.

7. A method according to claim 1, wherein the rotable segment comprises in addition to said grate support elements and grate panels at least one of the following: a radial lifter or a segment of a discharge cone.

8. A method according to claim 1, wherein a relining crane is mounted on the outside of the grinding mill for lifting the worn rotable segment and the new rotable segment.

9. A method according to claim 8, wherein the relining crane is a fixed base relining crane.

10. A method according to claim 8, wherein the relining crane is provided with gripping equipment for gripping on the rotable segment.

11. A maintenance apparatus provided on a grinding mill, wherein the maintenance arrangement comprises
gripping equipment configured to grip a worn rotable segment comprising at least one grate support element provided with a mounting flange at the outer perimeter of the grate support element configured to mount the grate support element to a shell of the grinding mill, and at least one grate panel attached to the grate support element,
unmounting equipment configured to unmount, from the outside of the grinding mill, the mounting flange of the grate support element from the shell of the grinding mill, and
lifting equipment configured to lift the unmounted worn rotable segment from the grinding mill.

12. A maintenance arrangement according to claim 11, wherein the lifting equipment comprises a relining crane mounted on the outside of the grinding mill and configured to lift the worn rotable segment and the new rotable segment.

13. A maintenance arrangement according to claim 12, wherein the relining crane is a fixed base relining crane.

14. A maintenance arrangement according to claim 12, wherein the relining crane is provided with gripping equipment for gripping on the rotable segment.

15. A maintenance arrangement according to claim 13, wherein the relining crane is provided with gripping equipment for gripping on the rotable segment.

16. A method according to claim 2, wherein the rotable segment comprises at least two grate support elements.

17. A method according to claim 2, wherein the grate of the grinding mill is formed of 3 to 12 rotable segments, whereby each of the rotable segments forms a segment of the grate in the range of 30 degrees to 120 degrees of the complete grate.

18. A method according to claim 3, wherein the grate of the grinding mill is formed of 3 to 12 rotable segments, whereby each of the rotable segments forms a segment of the grate in the range of 30 degrees to 120 degrees of the complete grate.
